(19) United States
(12) Patent Application Publication
(10) Pub. No.: US 2007/0231504 A1
(43) Pub. Date: Oct. 4, 2007

(54) Brightness enhancing film and fabrication method thereof

(75) Inventor: Fung Hsu Wu, Taoyuan County (TW)

Correspondence Address: QUINTERO LAW OFFICE, PC, 2210 MAIN STREET, SUITE 200, SANTA MONICA, CA, 90405, US

(73) Assignee: DAXON TECHNOLOGY INC., TAOYUAN (TW)

(21) Appl. No.: 11/499,117

(22) Filed: Aug. 3, 2006

(30) Foreign Application Priority Data
Mar. 30, 2006 (TW) TW95111178

(51) Int. Cl. C09K 19/00

(52) U.S. Cl. 428/1.3

(57) ABSTRACT

A brightness enhancing film and fabrication method thereof. The brightness enhancing film comprises a plurality of nanoparticles dispersed in a polymer film. Dispersion density of the nanoparticles along a non-stretching direction is about 5-10 times that along a stretching direction. A combination of the brightness enhancing film and a quarter wavelength plate (λ/4 plate) is interposed between a display panel and a backlight module, thereby improving brightness and reducing power consumption.

### BACKGROUND OF THE INVENTION

1. Field of the Invention

The invention relates to a brightness enhancing film, and in particular to a brightness enhancing film having nanoparticles and fabrication method thereof.

2. Description of the Related Art

Recently, liquid crystal displays are popular due to their low power consumption and high brightness. Polarizers only allow less than half of incident light passing. One way to increase the brightness of display is to raise brightness of the back lighting module. However, this increases the power consumption. Thus, it is important to increase transmittance and utilization of light for enhancing brightness and reducing power consumption.

3M provides a dual brightness enhancing film (DBEF) to enhance utilization of light. The DBEF is a reflective polarizer. FIG. 1 is a schematic stereograph of a conventional DBEF reflective polarizer cross depositing two different polymers A and B. The two polymers are formed a multi-layered structure by co-extruding and sticking prior to stretching along X-axis of the film. The X-axis is defined as a non-permeable axis (stretching axis) and the Y-axis is defined as a permeable axis.

After stretching, the refractive index of polymer A along the stretching axis is 1.88(Nax) and the refractive index of the permeable axis is 1.64(Nay). The refractive index of polymer B is not changed by the stretching process, both refractive indexes of the stretching axis and the permeable axis are 1.64(Nbx=Nby). Thus, light along the permeable axis can be guided through the reflective polarizer. The direction of light along the non-permeable axis is changed because the refractive indices of front and rear layers are different. Finally, total reflection reverses the direction of light back into the backlight module. Through recombination of the light source, light is reflected to the reflective polarizer to achieve reuse of the light source.

FIG. 2 is a cross section of a conventional liquid crystal display module with a cholesteric liquid crystal plate and a quarter wavelength plate, wherein the upper polarizer 210 and lower polarizer 206 sandwich the display panel 208. The quarter wavelength plate 204 and the cholesteric liquid crystal plate 202 are under the lower polarizer 206, wherein the cholesteric liquid crystal plate divides the light 212 into left-and right-polarized light. The quarter wavelength plate transfers the left-polarized light 214 passing through the cholesteric liquid crystal plate into the linear polarized light 216 into the display panel. The right-polarized light 218 is reflected to backlight module 200 and recombines with the light source to partly transfer into left-polarized light 220. Through the quarter wavelength plate, the left-polarized light 220 is transferred into linear polarized light 222 into the display panel. By transferring the light into the linear polarized light into the display panel, backlight and brightness of the display are enhanced.

The cost of DBEF reflective polarizer and cholesteric liquid crystal plate is high. Thus a more cost-effective brightness enhancing film is required for reuse of the backlight for enhanced brightness and reduced power consumption.

### BRIEF SUMMARY OF THE INVENTION

The invention provides a brightness enhancing film for increasing brightness of display and reducing power consumption, with lower fabrication costs.

The invention provides a brightness enhancing film, comprising a plurality of nanoparticles dispersed in a polymer film, wherein dispersion of the nanoparticles in the polymer film includes a stretching direction and a non-stretching direction, and a dispersion density of the nanoparticles along the stretching direction is different from the non-stretching direction. Diameter of the nanoparticles is from 100 to 200 nm. The dispersion density of the nanoparticles is from 1 to 100 particles/(μm)³, and the dispersion density of the nanoparticles along the non-stretching direction is 5-10 times that along the stretching direction.

The invention provides a method of fabricating the brightness enhancing film, comprising mixing a plurality of nanoparticles with a polymer or a polymer precursor, processing the mixture into a film which the plurality of nanoparticles are uniformly dispersed, and stretching the film along a stretching direction, such that dispersion density of the nanoparticles along a non-stretching direction is 5 to 10 times that along the stretching direction and the nanoparticles are non-uniformly dispersed in the film. The nanoparticles comprise metal or dielectric material. The polymer comprises a thermoset or a thermoplastic polymer. The thickness of the brightness enhancing film is from 20 to 200 μm.

The invention further provides a liquid crystal display module, comprising a display panel, a backlight module, a quarter wavelength plate and a brightness enhancing film as disclosed interposed between the display panel and the backlight module with the brightness enhancing film facing the display panel, and a pair of polarizers sandwiching the display panel. The brightness enhancement of liquid crystal display module of the invention is 1.2 to 2, thus the power consumption of the liquid crystal display module can be reduced.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic stereograph of a conventional DBEF reflective polarizer;

FIG. 2 is a schematic cross section of a conventional liquid crystal display module with a cholesteric liquid crystal plate and a quarter wavelength plate;

FIG. 3 is a schematic plan view of a brightness enhancing film according to an embodiment of the invention;

FIG. 4 is a schematic cross section of a liquid crystal display module with a brightness enhancing film and a quarter wavelength plate according to an embodiment of the invention.

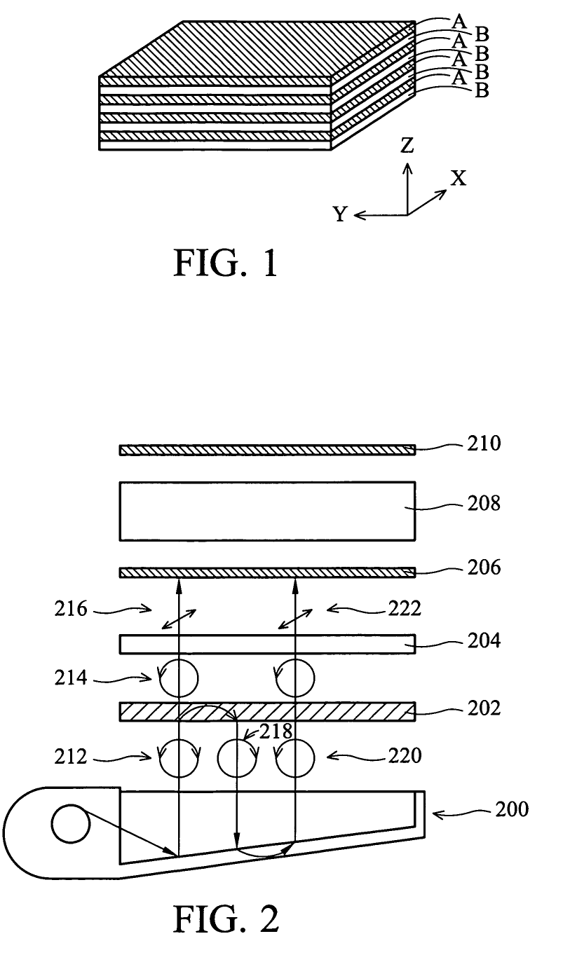

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a brightness enhancing film, comprising a plurality of nanoparticles dispersed in a polymer film. Light scattering comprises Rayleigh and Mie scattering. Rayleigh scattering is light scattered by smaller particles having diameter of 0.01 to 0.1 μm, wherein the particles scatter specific light of the spectrum. Mie scattering is light scattered by bigger particles having diameter of 0.1 to 1 μm, wherein the particles scatter all light of the spectrum. The brightness enhancing film of the invention comprises nanoparticles with diameter of about 100 to about 200 nm such that light is scattered by Mie scattering, and all light of the spectrum is scattered into white light.

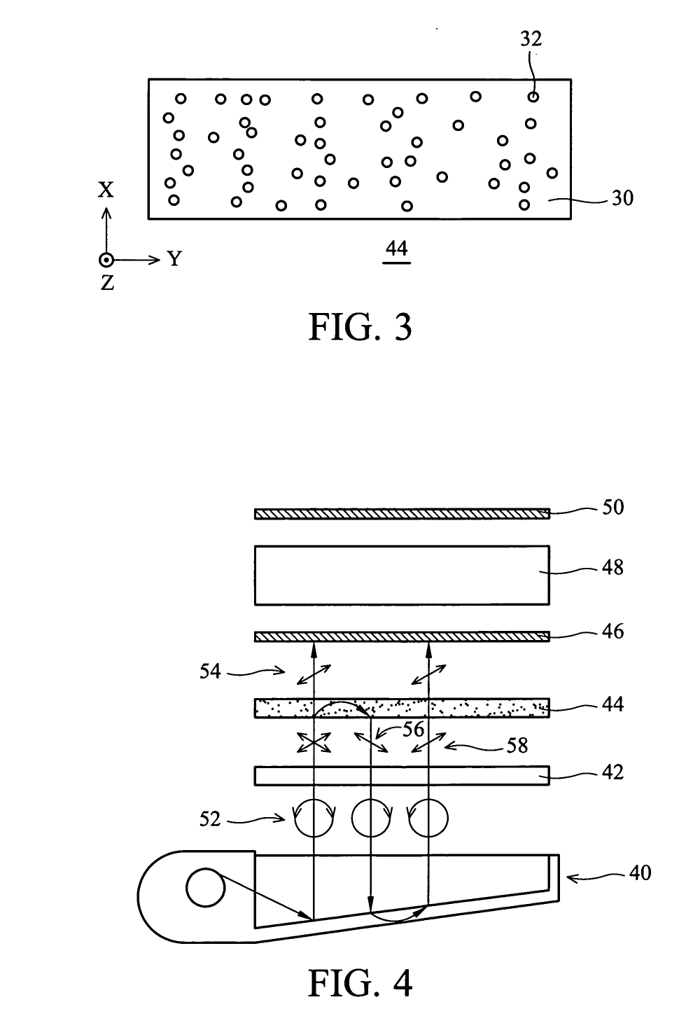

As shown in FIG. 3, the plan view of a brightness enhancing film according to an embodiment of the invention is the nanoparticles 32 dispersed in a polymer film 30. The dispersion of the nanoparticles 32 in the polymer film 30 includes a stretching direction (Y-axis) and a non-stretching direction (X-axis), with the thickness direction Z-axis. Dispersion density of the nanoparticles along the stretching direction is different from that along the non-stretching direction. After stretching, the dispersion density of the nanoparticles along the Y-axis and the X-axis is about 1 to 100 particles/(μm)³. The dispersion density of the nanoparticles along the non-stretching direction is 5-10 times that along the stretching direction. After stretching, thickness of the brightness enhancing film is about 20 to about 200 μm.

The nanoparticles 32 in the brightness enhancing film may comprise metal or dielectric materials. Suitable metals include Au, Ag, Pt, Pd or the like, and suitable dielectric materials include glass, ceramic, SiO₂ or the like. Nanoparticles of metal are preferred because their refractive index exceeds that of dielectric material, as does light scattering ability thereof. The polymer film 30 comprises a thermoset or a thermoplastic polymer such as polycarbonate(PC), polyvinyl Alcohol (PVA), polystyrene(PS), polymethyl methacrylate(PMMA), polypropylene(PP), polyvinyl pyrrolidone(PVP), poly(2-ethyle-2-oxazoline)(POZ), polyurethane(PU), polyimide(PI) or the like.

A method of fabricating a brightness enhancing film according to an embodiment of the invention comprises a plurality of nanoparticles mixed with a polymer or a polymer precursor and the mixture processed into a film which the plurality of nanoparticles are uniformly dispersed. The film is stretched along Y-axis. After stretching, the film is formed into a brightness enhancing film of the invention. The dispersion density of the nanoparticles in the brightness enhancing film along X-axis is 5 to 10 times that along Y-axis and the plurality of nanoparticles are non-uniformly dispersed in the film. The brightness enhancing film has a thickness about 20 to about 200 μm.

A method of fabricating a brightness enhancing film having metal nanoparticles comprises mixing a metal compound with a polymer or a polymer precursor solution. Suitable metal compounds include HAuCl₄, AgCF₃SO₃ or the like. Suitable polymers include poly(2-ethyle-2-oxazoline)(POZ), polyvinyl pyrrolidone(PVP) or the like. Polymer precursors such as polyamic acid(PAA) are also applicable. The mixture is coated on a glass substrate and a solvent of the mixture evaporated into a film. The film is irradiated by UV light to reduce metal ions to metal nanoparticles. The metal nanoparticles are uniformly dispersed in the polymer or polymer precursor to form a compound film. The film is extruded along Y-axis with rollers at 40-50° C. for stretching. The film is then formed into a brightness enhancing film. The dispersion density of metal nanoparticles in the brightness enhancing film along X-axis is 5 to 10 times that along Y-axis and the metal nanoparticles are non-uniformly dispersed in the film. After stretching, the polymer precursor base film requires additional curing. For example, polyamic acid(PAA) base film requires curing at 320° C. for imidization into polyimide(PI). The brightness enhancing film has a thickness about 20 to about 200 μm.

As shown in FIG. 4, a cross section of a liquid crystal display module of the invention comprises the brightness enhancing film 44 under the lower polarizer 46, the quarter wavelength plate 42 under the brightness enhancing film 44, the upper polarizer 50 and the lower polarizer 46 sandwiching the display panel 48, and the backlight module 40 under the quarter wavelength plate 42.

When light 52 passes through the brightness enhancing film 44 and the quarter wavelength plate 42, the P polarized light 54 of light 52 passes through the brightness enhancing film 44. The S polarized light 56 of light 52 is scattered by the nanoparticles of brightness enhancing film 44 and passes through the quarter wavelength plate 42 to return into the backlight module 40. The S polarized light is reflected by the reflector of the backlight module and passes through the quarter wavelength plate 42 again and converted to P polarized light 58 and into display panel 48. Light 52 is thus used again to enhance brightness and reduce power consumption. The brightness enhancement of the liquid crystal display module of the invention is 1.2 to 2.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A brightness enhancing film, comprising:
a polymer film; and
a plurality of nanoparticles dispersed in the polymer film, with dispersion of the nanoparticles in the polymer film including a stretching direction and a non-stretching direction, with dispersion density of the nanoparticles along the stretching direction different from that along the non-stretching direction.

2. The brightness enhancing film as claimed in claim 1, wherein the dispersion density of the nanoparticles along the non-stretching direction is 5-10 times that along the stretching direction.

3. The brightness enhancing film as claimed in claim 1, wherein the polymer film comprises a thermosetting or a thermoplastic polymer.

4. The brightness enhancing film as claimed in claim 1, wherein the nanoparticles comprises a metal or dielectric material.

5. The brightness enhancing film in claim 1, wherein the nanoparticles are metal.

6. The brightness enhancing film as claimed in claim 1, wherein the nanoparticles have a diameter from 100 to 200 nm.

7. The brightness enhancing film as claimed in claim 1, wherein the dispersion density of the nanoparticles is from 1 to 100 particles/(μm)³.

8. The brightness enhancing film as claimed in claim 1, which has a thickness from 20 to 200 μm.

9. A method of fabricating a brightness enhancing film, comprising:
mixing a plurality of nanoparticles with a polymer or a polymer precursor;
processing the mixture into a film, the plurality of nanoparticles uniformly dispersed in the film; and
stretching the film along a stretching direction, such that the dispersion density of the nanoparticles along the stretching direction is different from that along a non-stretching direction.

10. The method as claimed in claim 9, wherein the dispersion density of the nanoparticles along the non-stretching direction is 5-10 times that along the stretching direction.

11. The method as claimed in claim 9, wherein the diameter of the nanoparticles is from 100 to 200 nm.

12. The method as claimed in claim 9, wherein the dispersion density of the nanoparticles is from 1 to 100 particles/(μm)³.

13. The method as claimed in claim 9, wherein the nanoparticles comprise a metal or dielectric material.

14. The method as claimed in claim 9, wherein the polymer comprises a thermosetting or a thermoplastic polymer.

15. The method as claimed in claim 9, wherein the nanoparticles are metal.

16. The method as claimed in claim 9, wherein a thickness of the brightness enhancing film is from 20 to 200 μm.

17. A liquid crystal display module, comprising:
a display panel;
a backlight module;
a quarter wavelength plate and a brightness enhancing film as claimed in claim 1 interposed between the display panel and the backlight module with the brightness enhancing film facing the display panel; and
a pair of polarizers sandwiching the display panel.
